(19) United States
(12) Patent Application Publication
(10) Pub. No.: US 2007/0112626 A1
(43) Pub. Date: May 17, 2007

(54) Computer interactive customer relationship management system

(76) Inventor: Michael G. Daly, Melbourne Beach, FL (US)

Correspondence Address: BRYAN W. BOCKHOP, ESQ., 2375 MOSSY BRANCH DR., SNELLVILLE, GA, 30078, US

(21) Appl. No.: 11/455,430

(22) Filed: Jun. 19, 2006

Related U.S. Application Data
(60) Provisional application No. 60/737,177, filed on Nov. 16, 2005.

(51) Int. Cl. G06Q 30/00

(52) U.S. Cl. 705/14

(57) ABSTRACT

In a method for managing a relationship with a plurality of participants relating to a predetermined subject, each participant is presented a participant data input interface, which includes a participant identification data field, a participant goal indication data field, and a participant experience data field. A targeted participant list, including each participant that input a predetermined goal in the goal indication field, is generated. A past participant list of participants who input into a participant experience data field information indicating having had a desirable experience relating to the predetermined goal is generated and a selected number of participants listed therein are added to the targeted participant list. A targeted marketing contact is transmitted to each participant listed on the targeted participant list.

### CROSS-REFERENCE TO RELATED APPLICATION(S)

This application claims the benefit of U.S. Provisional Patent Application Ser. No. 60/737,177, filed Nov. 16, 2005, the entirety of which is hereby incorporated herein by reference.

### BACKGROUND OF THE INVENTION

1. Field of the Invention

The present invention relates to customer relationship management systems and, more specifically, to an interactive customer relationship management system.

2. Description of the Prior Art

Customer Relationship Management (CRM) systems help to organize and manage relationships between businesses and customers. Generally, CRM systems enable organizations to manage their customer relationships through the use of automated procedures for interacting with those customers. Effective CRM systems provide the ability to analyze customer goals and experience, automate the business processes used to maintain and improve relationships with the customers, and facilitate communication with the customers. Essentially, CRM systems seek to improve customer service and encourage greater interaction with the customer. A good CRM program will allow a business to acquire a customer, service the customer, increase the value of the customer to the company, retain good customers, and determine which customers should be retained or given a higher level of service. A good CRM program can improve customer service by improving communication between the company and the customer.

The use of e-mail in business is often one of the least expensive communication methods with respect to many customers. However, if customer contact e-mails are broadcast indiscriminately, the customers may be likely to discard the e-mails, or they may even be filtered out as “junk” e-mail. Generally, the average consumer is most likely to view an e-mail if it indicates that it was targeted to the individual, not merely broadcast randomly.

Many organizations seek to organize their contact lists in meaningful ways. However, most Internet-based business and organizations tend to send out information through the “mass mailing” approach, in which many people get the same information. It often confuses the recipient when he receives a mailing that might be from an organization in which he may have some interest, but in which the mailing (or e-mailing) is not targeted to his specific interests.

Therefore, there is a need for customer relationship management system that identifies specific interests of potential contactees.

There is also a need for customer relationship management system that uses electronic contact with potential customers and participants in an effective targeted manner.

There is also a need for customer relationship management system that contacts people regarding to specific interests that the people may have.

### SUMMARY OF THE INVENTION

The disadvantages of the prior art are overcome by the present invention which, in one aspect, is a method for managing a relationship with a plurality of participants relating to a predetermined subject, in which each participant is presented, via a local computer display screen and via a global computer network, a participant data input interface. The data input interface includes inputs for the following information: a participant identification data field that allows the participant to input identifying information about the participant, a participant goal indication data field that allows the participant to input goal information that describes at least one goal that the participant has relating to the subject, and a participant experience data field that allows the participant to input experience information that describes at least one aspect of an experience that the participant had relating to the subject. Input received from each participant via the participant data input interface is stored in a computer-readable memory. A targeted participant list, including each participant that input a predetermined goal in the goal indication field, is generated with a central computer. A past participant list is generated with the central computer. The past participant list is a list of participants who input into the participant experience data field information indicating having had a desirable experience relating to the predetermined goal. A selected number of participants listed on the past participant list is added to the targeted participant list. A targeted marketing contact relating to the predetermined subject is transmitted to each participant listed on the targeted participant list.

In another aspect, the invention is a device for managing a relationship with a participant relating to a predetermined subject. The device is in communication with a remote server via a global computer network. The devices includes a digital computer, including a user input device and a display, that is in communication with the global computer network. The computer-readable memory is in communication with the digital computer and has stored thereon a computer program that causes the digital computer to execute a plurality of instructions. A participant data input interface is presented on the display, the data input interface including inputs for the following information: a participant identification data field that allows the participant to input identifying information about the participant; a participant goal indication data field that allows the participant to input goal information that describes at least one goal that the participant has relating to the subject; and a participant experience data field that allows the participant to input experience information that describes at least one aspect of an experience that the participant had relating to the subject. Input is received from the participant. The input received from the participant through the participant data input interface is transmitted to the remote server via the global computer network.

In yet another aspect, the invention is an apparatus for administering a relationship with a plurality of participants relating to a predetermined subject, that includes a digital central server and a computer-readable memory. The digital central server is in communication with the global computer network. The computer-readable memory is in communication with the digital central server and has stored thereon a computer program that causes the digital central server to execute a plurality of instructions. Input is received from the plurality of participants. A targeted participant list is generated. The Targeted participant list includes each participant of the plurality of participants that input a predetermined goal in a goal indication field. A past participant list is generated. The past participant list includes each of the participants who input into a participant experience data field information indicating having had a desirable experience relating to the predetermined goal. A predetermined number of participants listed on the past participant list is added to the targeted participant list. A targeted marketing contact relating to the predetermined subject is transmitted to each participant listed on the targeted participant list.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram showing a relationship between several computers and a central server.

FIG. 2 is a diagram showing a participant user interface screen.

FIG. 3 is a diagram showing a second participant user interface screen

FIG. 4 is a diagram showing an administrator's user interface screen

FIG. 5 is a diagram showing a second administrator's user interface screen.

FIG. 6 is a flow chart showing one method of sorting participant records according to interest in a predetermined goal.

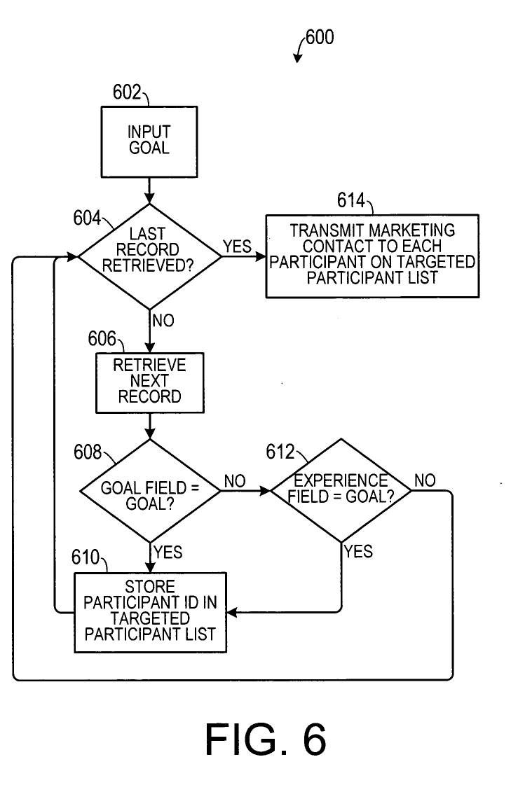

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein, “global computer network” includes the Internet.

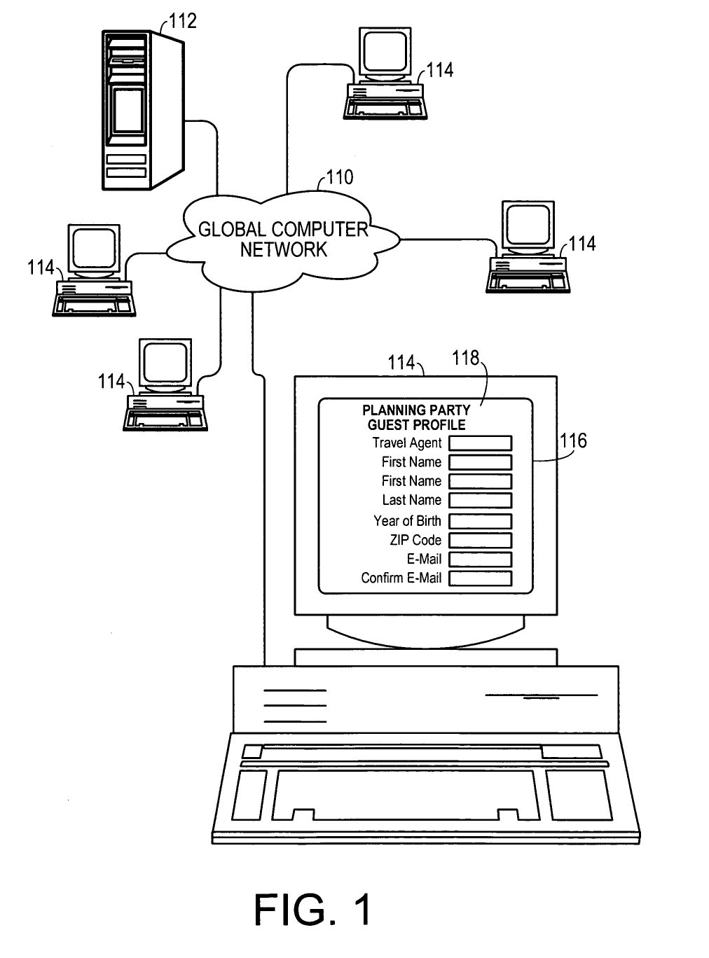

As shown in FIG. 1, one embodiment of the invention employs a remote server 112 in communication with a plurality of local computers 114 via a global computer network 110. Each local computer 114 includes a display screen 116 upon that may be displayed a participant data input interface 118, which may take the form of a web site. The participant data input interface 118 includes, for example, the following input fields: a participant identification data field that allows the participant to input identifying information about the participant; a participant goal indication data field that allows the participant to input goal information that describes at least one goal that the participant has relating to a subject; and a participant experience data field that allows the participant to input experience information that describes at least one aspect of an experience that the participant had relating to the subject. The input received from each participant via the participant data input interface is stored in a computer-readable memory, which could be located in the local computer 114 or in the server 112, or both.

The server 112 generates a targeted participant list that includes each participant that input a predetermined goal in the goal indication field. The server 112 can also generate a past participant list including participants who input into the participant experience data field information indicating having had a desirable experience relating to the predetermined goal. The server 112 can add a selected number of participants listed on the past participant list to the targeted participant list. The server 112 then transmits to each participant listed on the targeted participant list a targeted marketing contact relating to the predetermined subject.

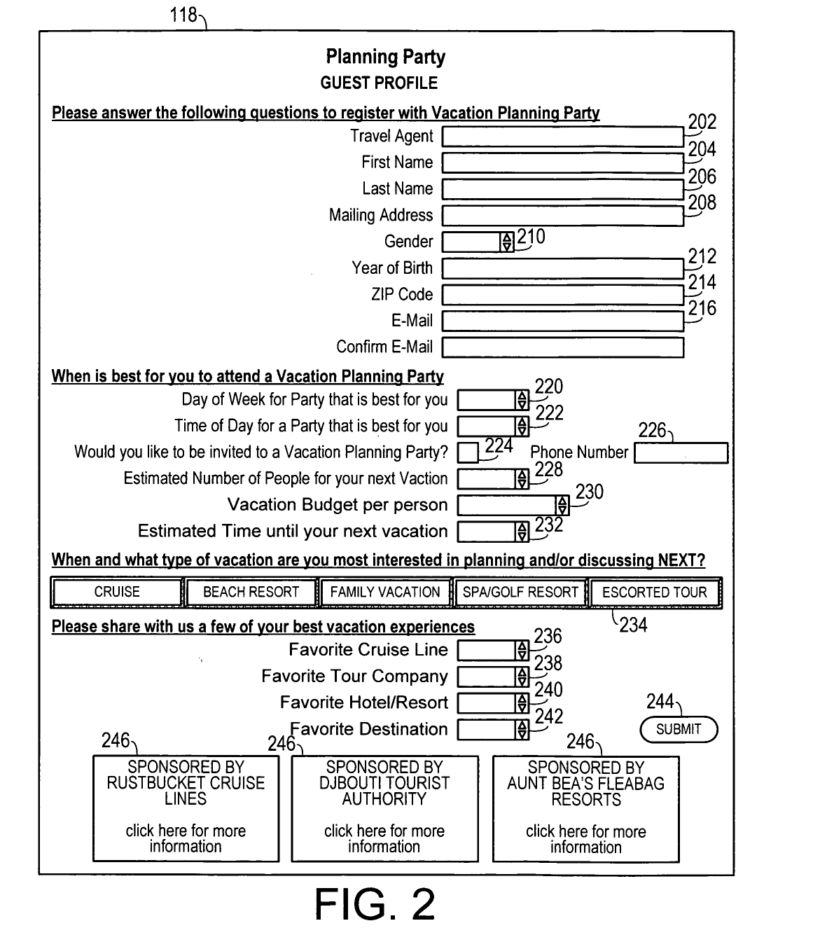

As shown in FIG. 2, one embodiment may be directed to the travel industry. (It is understood that the invention is not limited to use with a single industry, but may be applied to many other uses, including philanthropy and special interest organizations. It is intended that the scope of the claims below include all such applications.) In the travel industry embodiment, the participant data input interface 118 includes data input fields that allow the participant to enter such information as: the participant's travel agent 202, the participant's first name 204 and last name 206, the participant's mailing address 208, the participant's gender 210, the participant's year of birth 212, the participant's zip code 214, and the participant's e-mail address 216.

The participant data input interface 118 includes data input fields that ask for the day of the week that the participant is most likely to be available for a vacation planning party 220, the time most convenient for the participant 222, a check box 224 through which the participant indicates a desire to be invited to a vacation planning party. If checked, the participant is asked for a phone number 226. The participant is also asked to provide the number of people in his group for his next vacation 228, the proposed vacation budget per person 230, and the expected time until his next vacation 232.

The participant data input interface 118 also asks for the participant to identify what type of vacation the participant is planning on going on next. This may be entered, for example, through the clicking on several buttons 234. The participant is also asked to identify his favorite cruise line 236, favorite tour company 238, favorite hotel or resort 240 and favorite vacation destination 242. Once the initial data is entered, the participant clicks on a “submit” button 244 and the data is transmitted to the server 112 via the global computer network 110. Also, the participant data input interface 118 may include sponsor links 246 to web sites of participating sponsors. The server 112 can choose the links best suited for a given participant based on the participant's earlier inputs.

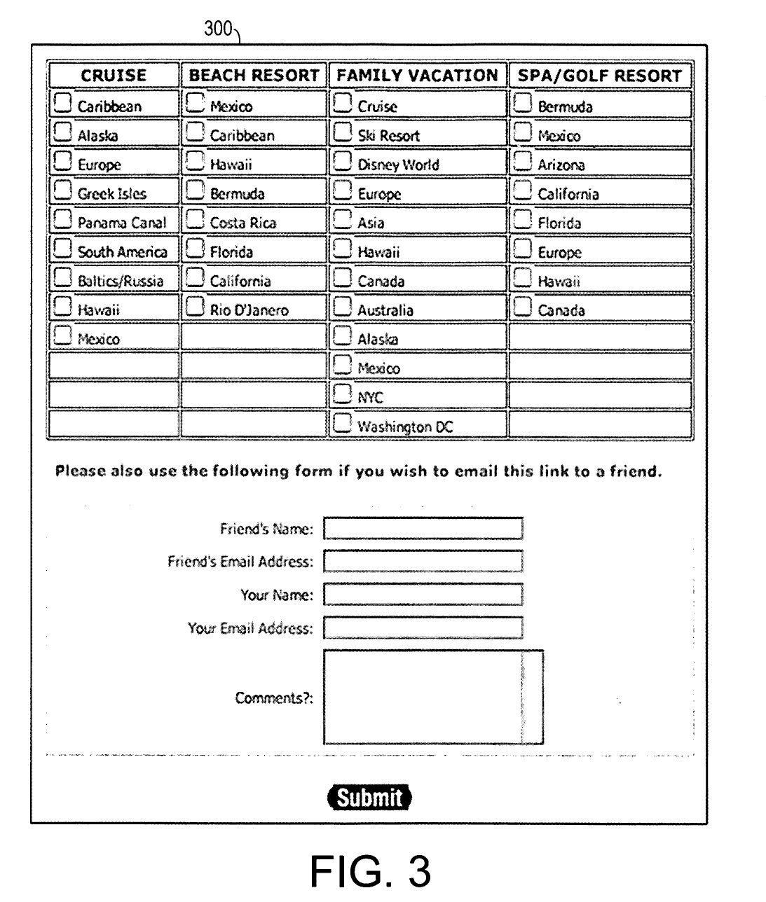

As shown in FIG. 3, once the participant has completed the initial data input, his browser can be directed to subsequent screens 300 that seek additional information, such as identification of favorite cruise locations, beach resorts, family vacation locations and spa or golf resort locations. The user can also be provided with the opportunity to forward a link to the web site.

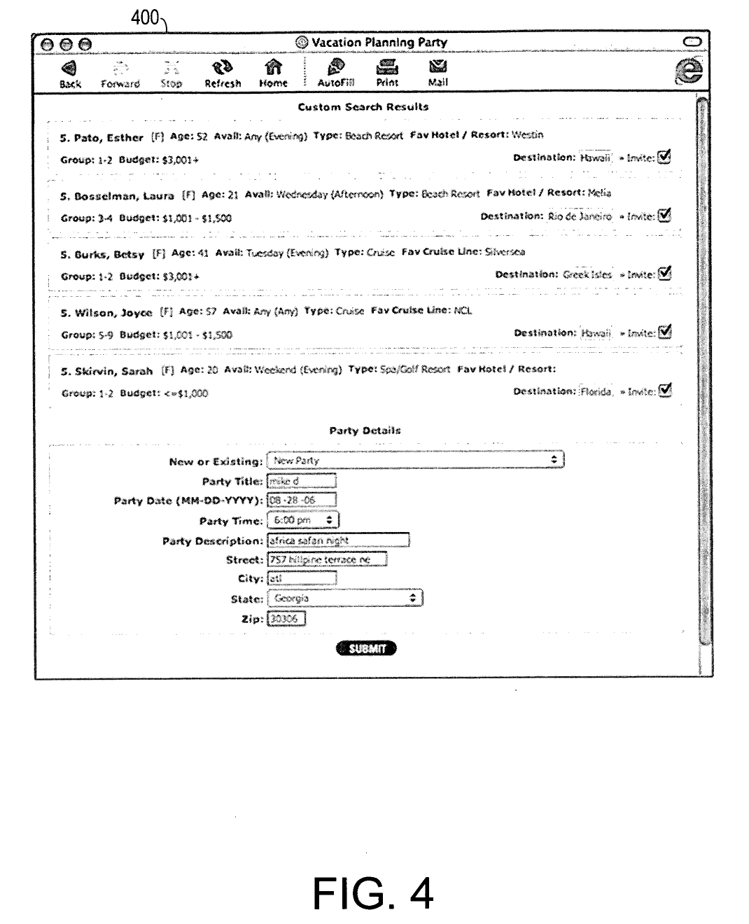

As shown in FIG. 4, once the above-discussed information is received from several participants, a custom search results page 400 is presented to an administrator, who then uses the information to generate a targeted contact of all of the participants showing similar interests. This screen allows the administrator to generate, for example, an invitation to all participants who have indicated interest in a certain type of vacation and who have indicated availability at a given time. The invitation may be sent automatically as an e-mail, or the system can generate printed mailings or a telephone contact list. In one embodiment, the system can also determine how far each potential invitee is from the location of a party or meeting and generate a targeted contact list that includes only the participants that are within a predetermined range of the location.

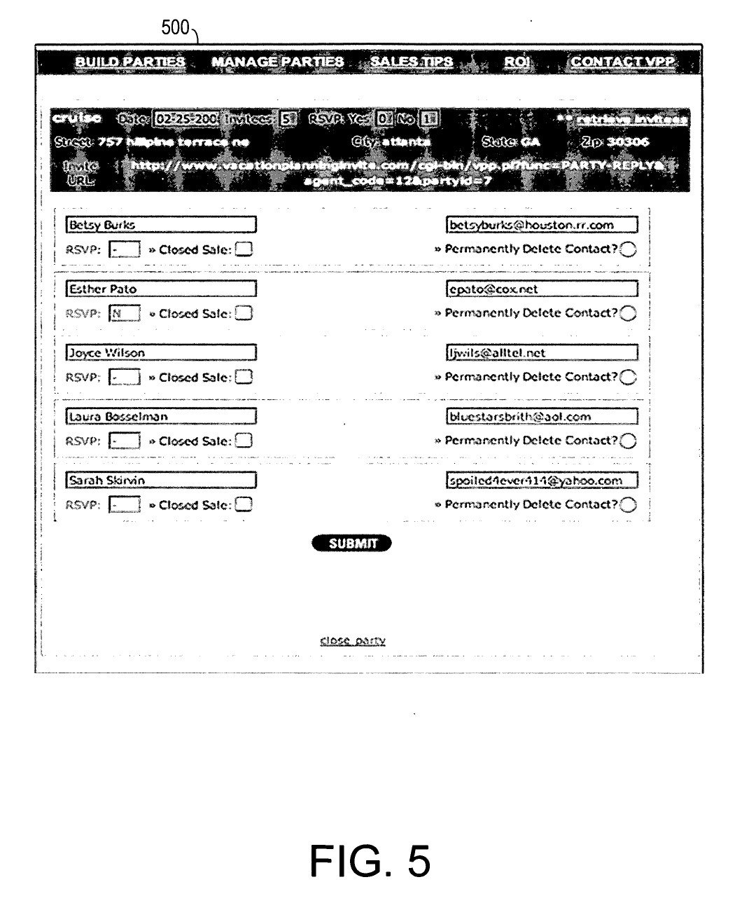

As shown in FIG. 5, a manage parties page 500 allows the administrator to track individuals who have been invited to a planning party through a targeted contact. The tracking can include information as to whether the participant has RSVP'ed to the planning party invitation and whether the administrator has closed a sale with the participant.

In one general example of a method 600 of generating a targeted participant list (e.g., an invitation list for a vacation planning party), the administrator inputs goal information about the type of planning party list being generated 602. The system determines 604 if it has already viewed the last participant record of all of the available records and, if no, retrieves the next record 606. The system then determines 608 if the data field corresponding to a selected one of the participant's goals corresponds to the administrator's goal and, if not, then the system determines 612 whether a participant's selected past experience corresponds to the administrator's goal. If either the participant's goal or the participant's past experience corresponds to the administrator's goal, then an identification of the participant is stored 610 in a targeted participant list. Otherwise, the system returns to step 604. Once all of the records have been retrieved and reviewed, a targeted marketing contact (such as an invitation to a vacation planning party or a subject-specific meeting) is transmitted 614 to each participant on the targeted participant list. By including participants who have indicated good experiences in the past with respect to the subject of the current meeting or party, the administrator may make the meeting or party more productive by letting those with past experiences to testify to the other participants about their positive experiences. For example, if the subject of the planning party is a cruise to Alaska, testimony from people who have recently returned from an Alaska cruise might encourage more participants to sign up for a future cruise. An incentive may be provided to past participants to encourage them to attend the planning party.

This invention may be used to assemble information regarding people who want to explore vacation options. It may also be useful to assemble information about people who would like to participate or learn more about a group. For example, it could be used as a participant information collection system for people having common health issues, or political beliefs. It could also be used to disseminate information to participants who have indicated an interest in subjects that they would like to learn more about. It could also be used by scholastic institutions to assemble information about potential applicants. It will be readily seen that the system of the invention could be used with many similar applications.

The server may be programmed to generate a location list that includes each address of each participant on the targeted participant list that is within a predetermined range of a preselected location. The server may also be programmed to modify the targeted participant list so as to include only participants listed on the location list prior to execution of the transmitting step. The server may also be programmed to include a multiple event management module that allows a user to maintain a first targeted participant list relating to a first event and at least a second targeted participant list relating to a second event. The CD-ROM Appendix filed herewith includes computer programming code that embodies one example of the invention.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method for managing a relationship with a plurality of participants relating to a predetermined subject, comprising the steps of:
a. for each participant, presenting on a local computer display screen, via a global computer network, a participant data input interface, the data input interface including the following information inputs:
i. a participant identification data field that allows the participant to input identifying information about the participant;
ii. a participant goal indication data field that allows the participant to input goal information that describes at least one goal that the participant has relating to the subject; and
iii. a participant experience data field that allows the participant to input experience information that describes at least one aspect of an experience that the participant had relating to the subject;
b. storing, in a computer-readable memory, input received from each participant via the participant data input interface;
c. generating, with a central computer, a targeted participant list including each participant that input a predetermined goal in the goal indication field;
d. generating, with the central computer, a past participant list of participants who input into the participant experience data field information indicating having had a desirable experience relating to the predetermined goal and adding a selected number of participants listed on the past participant list to the targeted participant list; and
e. transmitting to each participant listed on the targeted participant list a targeted marketing contact relating to the predetermined subject.

2. The method of claim 1, wherein the targeted marketing contact comprises an invitation to a meeting relating to the predetermined subject.

3. The method of claim 2, wherein the meeting comprises a party for planning a vacation.

4. The method of claim 3, wherein the participant goal indication data field allows input regarding goal information that comprises information regarding a type of vacation that the participant seeks to take.

5. The method of claim 3, wherein the participant goal indication data field allows input regarding goal information that comprises information regarding a budget that the participant expects to spend on the vacation.

6. The method of claim 3, wherein the participant goal indication data field allows input regarding goal information that comprises information regarding how many people that the participant expects to include on the vacation.

7. The method of claim 3, wherein the participant goal indication data field allows input regarding goal information that comprises information regarding when the participant to take the vacation.

8. The method of claim 3, wherein the participant experience data field includes a favorite provider input.

9. The method of claim 3, wherein the participant experience data field includes a favorite destination input.

10. The method of claim 2, wherein the meeting comprises a philanthropy-related meeting.

11. The method of claim 10, wherein the goal information comprises information regarding how the participant would like to participate in a group.

12. The method of claim 10, wherein the goal information comprises information regarding an issue that the participant would like to learn about.

13. The method of claim 1, wherein the data input interface further includes an availability input that allows the participant to input availability information about when the participant would be available to attend a meeting and further comprising the steps of:
a. storing, in a computer-readable memory, availability information received from each participant via the participant data input interface;
b. generating, with a computer, an availability list that includes each participant that whose availability input indicates that the participant will be available at a preselected time; and
c. modifying, with a computer, the targeted participant list so as to include only participants listed on the availability list prior to execution of the transmitting step.

14. The method of claim 1, wherein the identifying information comprises an address of the participant.

15. The method of claim 14, further comprising the steps of:
a. generating, with a computer, a location list that includes each address of each participant on the targeted participant list that is within a predetermined range of a preselected location; and
b. modifying, with a computer, the targeted participant list so as to include only participants listed on the location list prior to execution of the transmitting step.

16. The method of claim 1, further comprising the step of displaying, on the participant data input interface, at least one link to a web site of a sponsoring entity.

17. A device for managing a relationship with a participant relating to a predetermined subject, the device in communication with a remote server via a global computer network, comprising:
a. a digital computer, including a user input device and a display, that is in communication with the global computer network; and
b. a computer-readable memory, in communication with the digital computer, that has stored thereon a computer program that causes the digital computer to execute instructions including:
i. present on the display a participant data input interface, the data input interface including inputs for the following information:
(1) a participant identification data field that allows the participant to input identifying information about the participant;
(2) a participant goal indication data field that allows the participant to input goal information that describes at least one goal that the participant has relating to the subject; and
(3) a participant experience data field that allows the participant to input experience information that describes at least one aspect of an experience that the participant had relating to the subject;
ii. receive input from the participant;
iii. transmit to the remote server the input received from the participant, through the participant data input interface, via the global computer network.

18. The device of claim 17, wherein the identifying information comprises an address of the participant.

19. The device of claim 17, wherein the participant goal indication data field allows input regarding goal information that comprises information regarding a type of vacation that the participant seeks to take.

20. The device of claim 17, wherein the participant goal indication data field allows input regarding goal information that comprises information regarding a budget that the participant expects to spend on the vacation.

21. The device of claim 17, wherein the participant goal indication data field allows input regarding goal information that comprises information regarding when the participant to take the vacation.

22. The device of claim 17, wherein the goal information comprises information regarding how the participant would like to participate in a group.

23. The device of claim 17, wherein the goal information comprises information regarding an issue that the participant would like to learn about.

24. The device of claim 17, wherein the program further includes an instruction causing the computer to include, in the participant data input interface, at least one link to a web site of a sponsoring entity.

25. An apparatus for administering a relationship with a plurality of participants relating to a predetermined subject, comprising:
a. a digital central server that is in communication with a global computer network; and
b. a computer-readable memory, in communication with the digital central server, that has stored thereon a computer program that causes the digital central server to execute instructions including:
i. receive input from the plurality of participants;
ii. generate an targeted participant list of each participant of the plurality of participants that input a predetermined goal in a goal indication field;
iii. generate a past participant list of participants who input into a participant experience data field information indicating having had a desirable experience relating to the predetermined goal and adding a predetermined number of participants listed on the past participant list to the targeted participant list; and
iv. transmitting to each participant listed on the targeted participant list a targeted marketing contact relating to the predetermined subject.

26. The apparatus of claim 25, wherein the targeted marketing contact comprises an invitation to a meeting.

27. The apparatus of claim 25, wherein the computer program further causes the digital central server to execute instructions including:
a. store, in the computer-readable memory, availability information received from each participant via the participant data input interface;
b. generate an availability list that includes each participant that whose availability input indicates that the participant will be available at a preselected time; and
c. modify the targeted participant list so as to include only participants listed on the availability list prior to execution of the transmitting step.

28. The apparatus of claim 25, wherein the computer program further causes the digital central server to execute instructions including:
a. generate a location list that includes each address of each participant on the targeted participant list that is within a predetermined range of a preselected location; and
b. modify the targeted participant list so as to include only participants listed on the location list prior to execution of the transmitting step.

29. The apparatus of claim 25, wherein the computer program further comprises a multiple event management module that allows a user to maintain a first targeted participant list relating to a first event and at least a second targeted participant list relating to a second event.

30. The apparatus of claim 29, wherein the first event and the second event both comprise a sales event.
